(19) United States
(12) Patent Application Publication
(10) Pub. No.: US 2023/0126907 A1
(43) Pub. Date: Apr. 27, 2023

(54) BIOPOLAR MEMBRANE CELL FOR THE CAPTURE OF CARBON DIOXIDE

(71) Applicant: Skyre, Inc., East Hartford, CT (US)

(72) Inventors: Praveen Kolla, Vernon Rockville, CT (US); Trent M. Molter, South Windsor, CT (US)

(21) Appl. No.: 17/938,086

(22) Filed: Oct. 5, 2022

Related U.S. Application Data
(60) Provisional application No. 63/272,093, filed on Oct. 26, 2021.

(51) Int. Cl. B01D 53/32; H01M 8/0668; H01M 8/1004; H01M 8/04089; H01M 8/1007; H01M 8/0234; C25B 1/04; C25B 3/26; C25B 15/08; C25B 9/19

(52) U.S. Cl. CPC B01D 53/326; H01M 8/0668; H01M 8/1004; H01M 8/04089; H01M 8/1007; H01M 8/0234; C25B 1/04; C25B 3/26; C25B 15/08; C25B 9/19

(57) ABSTRACT

In an aspect, a bipolar membrane cell comprises a separation layer located in between an anode half-cell and a cathode half-cell; wherein the anode half-cell comprises a proton exchange membrane and an anode; where the proton exchange membrane is located in between the anode and the separation layer; wherein the cathode half-cell comprises an anion exchange membrane and a cathode; wherein the anion exchange membrane is located in between the cathode and the separation layer; and an external circuit connecting the anode and the cathode.

### CROSS REFERENCE TO RELATED APPLICATIONS

This application claims the benefit of U.S. Provisional Application Ser. No. 63/272,093, filed Oct. 26, 2021, the entire disclosure of which is incorporated herein by reference.

### BACKGROUND

As global carbon-dioxide (CO₂) emissions are on the rise and causing significant climate changes, it is essential to accelerate the efforts to reduce CO₂-levels to a pre-industrialization era. One way of helping to achieve this goal is the development of market-viable CO₂ mitigation strategies. However, many carbon-neutral or carbon-negative conversion technologies require concentrated CO₂ feedstock rather than the insignificant amounts (˜400 ppm) of CO₂ directly available from the air. To this context, many direct-air CO₂ capture technologies have been developed such as liquid or solid-based sorbent systems, fuel cell or dialysis-based electrochemical systems, and redox-based flow-battery systems. For example, the state-of-the-art liquid sorbent technologies for CO₂ capture-separation are essentially implemented by exposing high CO₂ soluble amine-based organic solutions at a high-surface-area air-liquid interface for CO₂ with a direct-capture step followed by CO₂ separation step via temperature-swing desorption. Likewise, solid-state sorbent technologies are realized via the pressure-swing-adsorption (PSA) systems that selectively capture CO₂ during the adsorption-step and separate CO₂ during the desorption-step. Nevertheless, these sorbent technologies require high-energy inputs for their high-temperature or high-pressure swing operations.

Improved technologies for capturing CO₂ are therefore desired.

### BRIEF SUMMARY

Disclosed herein is a bipolar membrane cell for the capture of carbon dioxide.

In an aspect, a bipolar membrane cell comprises a separation layer located in between an anode half-cell and a cathode half-cell; wherein the anode half-cell comprises a proton exchange membrane and an anode; where the proton exchange membrane is located in between the anode and the separation layer; wherein the cathode half-cell comprises an anion exchange membrane and a cathode; wherein the anion exchange membrane is located in between the cathode and the separation layer; and an external circuit connecting the anode and the cathode.

In addition to one or more of the features described herein, or as an alternative, further embodiments of the bipolar membrane cell may include the cathode half-cell further comprising a cathode side chamber and a carbon dioxide source stream in fluid communication with the cathode side chamber for delivering carbon dioxide to the cathode side chamber.

In addition to one or more of the features described herein, or as an alternative, further embodiments of the bipolar membrane cell may include the cathode half-cell further comprising a cathode side chamber and a carbon dioxide depleted stream in fluid communication with the cathode side chamber for withdrawing the carbon dioxide depleted stream from the cathode side chamber.

In addition to one or more of the features described herein, or as an alternative, further embodiments of the bipolar membrane cell may include the anode half-cell further comprising an anode side chamber and a hydrogen rich stream in fluid communication with the anode side chamber for delivering the hydrogen rich stream from the anode side chamber.

In addition to one or more of the features described herein, or as an alternative, further embodiments of the bipolar membrane cell may include the separation layer, the anode half-cell, and the cathode half-cell having a planar configuration relative to each other.

In addition to one or more of the features described herein, or as an alternative, further embodiments of the bipolar membrane cell may include the anode half-cell and the cathode half-cell being concentrically located to form a tubular bipolar membrane cell; and wherein the separation layer is concentrically located in between the anode half-cell and the cathode half-cell.

In addition to one or more of the features described herein, or as an alternative, further embodiments of the bipolar membrane cell may include the anode half-cell being located in a tube formed by the cathode half-cell; or wherein the cathode half-cell is located in a tube formed by the anode half-cell.

In addition to one or more of the features described herein, or as an alternative, further embodiments of the bipolar membrane cell may include the both the hydrogen rich stream and the carbon dioxide source stream being in fluid communication with a proximal end of the tubular bipolar membrane cell and wherein the carbon dioxide product stream is in fluid communication with a distal end of the tubular bipolar membrane cell.

In addition to one or more of the features described herein, or as an alternative, further embodiments of the bipolar membrane cell may include both the carbon dioxide product stream and the carbon dioxide source stream being in fluid communication with a proximal end of the tubular bipolar membrane cell and wherein the hydrogen rich stream and is in fluid communication with a distal end of the tubular bipolar membrane cell.

In addition to one or more of the features described herein, or as an alternative, further embodiments of the bipolar membrane cell may include the anode comprising platinum and the cathode comprises at least one of a non-platinum group metal.

In addition to one or more of the features described herein, or as an alternative, further embodiments of the bipolar membrane cell may include at least one of the separation layer comprising a porous carbon or wherein the separation layer has a thickness of 0.25 micrometer to 5 millimeters, or 1 micrometer to 1 millimeter.

In addition to one or more of the features described herein, or as an alternative, further embodiments of the bipolar membrane cell may include the separation layer comprising the porous carbon and wherein the porous carbon has at least one of a microporosity having pore diameters of less than 2 nanometer, a mesoporosity having pore diameters of 2 to 50 nanometers, a total pore volume of 0.0001 to 0.1 centimeters cubed per gram, a BET surface area of 2 to 500 m2/g, or 100 to 2,000 m2/g, or 500 to 1,000 m2/g, or an electrical conductivity of greater than or equal to 10-2 S/cm.

In addition to one or more of the features described herein, or as an alternative, further embodiments of the bipolar membrane cell may include a hydrogen withdrawal stream in fluid communication with the anode side chamber.

In another aspect, an apparatus comprises the bipolar membrane cell.

In another aspect, an apparatus is provided that comprises the bipolar membrane cell claimed herein. A water electrolyzer is in fluid communication with an inlet of the bipolar membrane cell via the hydrogen rich stream. A CO2 electrolyzer in fluid communication with an outlet of the bipolar membrane cell via the carbon dioxide stream.

In yet another aspect, a method of purifying a carbon dioxide stream comprises directing the carbon dioxide source stream comprising carbon dioxide to a cathode side chamber comprising a cathode half-cell that comprises an anion exchange membrane and a cathode; where the cathode is located on a side of the anion exchange membrane proximal to the cathode side chamber; and withdrawing a carbon dioxide depleted stream from the cathode side chamber; reacting the carbon dioxide with water at the cathode to form carbonate ions and bicarbonate ions and directing the carbonate ions and the bicarbonate ions through the anion exchange membrane to a separation layer; directing a hydrogen rich stream comprising hydrogen to an anode side chamber comprising an anode half-cell comprising a proton exchange membrane and an anode; where the anode is located on a side of the proton exchange membrane proximal to the anode side chamber; reacting the hydrogen at the anode to form protons and electrons and directing the protons through the proton exchange membrane to the separation layer; reacting the protons, the carbonate ions, and the bicarbonate ions in the separation layer to form carbon dioxide and water; and withdrawing a carbon dioxide product stream from the separation layer comprising the carbon dioxide and the water.

In addition to one or more of the features described herein, or as an alternative, further embodiments of the method may include directing at least a portion of the carbon dioxide product stream to at least one of a separation unit, a storage unit, a further direct-feed to CO2 electrolyzer cell.

In addition to one or more of the features described herein, or as an alternative, further embodiments of the method may include the carbon dioxide source stream comprising at least one of air or an off-gas from an industrial process.

In addition to one or more of the features described herein, or as an alternative, further embodiments of the method may include the carbon dioxide source stream comprising up to 50 volume percent of carbon dioxide based on the total volume of the stream on a dry basis.

In addition to one or more of the features described herein, or as an alternative, further embodiments of the method may include the hydrogen rich stream comprising 90 to 100 volume percent, or 95 to 99 volume percent of hydrogen based on the total volume of the hydrogen rich stream 30 on a dry basis.

In addition to one or more of the features described herein, or as an alternative, further embodiments of the method may include the carbon dioxide product stream comprising 90 to 100 volume percent of carbon dioxide based on the total volume of the carbon dioxide product stream.

In addition to one or more of the features described herein, or as an alternative, further embodiments of the bipolar membrane cell may include

The above described and other features are exemplified by the following figures, detailed description, and claims.

### BRIEF DESCRIPTION OF THE DRAWINGS

The following Figures are exemplary embodiments, which are provided to illustrate the present disclosure. The figures are illustrative of the examples, which are not intended to limit devices made in accordance with the disclosure to the materials, conditions, or process parameters set forth herein.

FIG. 1 is an illustration of an aspect of a bipolar membrane cell;

FIG. 2 is an illustration of an aspect of a bipolar membrane cell having a planar configuration;

FIG. 3 is an illustration of an aspect of a bipolar membrane cell having a tubular configuration; and

FIG. 4 is an illustration of support system (Balance of plant) comprising a bipolar membrane cell 10 in fluid communication with a CO₂RENEW process 300.

### DETAILED DESCRIPTION

A bipolar membrane cell was developed that can concentrate CO₂ via a single-step electrochemical capture-separation process from a gas mixture, for example, from direct air or from an industrial flue gas. The bipolar membrane cell comprises an anode half-cell membrane of a proton exchange membrane fuel cell (PEMFC) and cathode half-cell membrane of an anion exchange membrane fuel cell 1 (AEMFC). A separation layer that can have a mixed-ionic conductivity is located in between the two half-cell membranes. The separation layer can function as a CO₂ formation and separation region.

The bipolar membrane cell has several benefits over other systems including that it can concentrate CO₂ via a single-step electrochemical capture-separation process from direct air or industrial flue gas and that it can beneficially operate at low temperatures (for example of less than 100 degrees Celsius (° C.)). Further, the reaction used in the bipolar membrane cell to capture carbon dioxide can rely on the oxygen reduction reaction (ORR) that generates hydroxyl ions (OH⁻) which have faster equilibrium kinetics associated with CO₂ present at the air cathode of the anion exchange membranes fuel cells (AEMFC). Specifically, the primary cathodic ORR can spontaneously convert oxygen in air into hydroxyl ions (Off), which can readily capture CO₂ present in air and convert into carbonate (CO₃²⁻) or bicarbonate (HCO₃⁻) ions. Another unique advantage of these fuel cell-based CO₂ capture systems is that it can co-generate power from renewable hydrogen (fuel). Further, the CO₂ separated along with water from the bipolar membrane cell can be further utilized as a direct-feed stock for electrochemical CO₂-electrolysis, for example, using SKYRE's CO₂RENEW technology, to produce carbon-neutral organic liquids, syngas or high-energy-density fuels.

Further benefits of the present bipolar membrane cell can include one or more of the following: the system can be an all solid-state electrochemical device comprising no liquid electrolytes or moving parts; the CO₂ capture and separation can be implemented in a single device; the bipolar membrane cell can be used for either CO₂ direct-air capture or CO₂ capture from flue gas or the like; there can be a simultaneous CO₂-capture and power generation when operating at high current densities (>500 mA/cm²); expended H₂ can be regenerated using water electrolysis when integrated with a renewable energy source such as solar/wind energy; the bipolar membrane cell can be tolerant to chemical contaminants such as CO, NOx, H₂S, etc.; or the bipolar membrane cell can be ideal for continuous CO₂ scrubbing application in a closed loop life-support or controlled environments, for example, in submarines.

The following closed loop system can be envisioned when the bipolar membrane fuel cell is employed, for example, as a CO₂ scrubber in a closed loop environments.

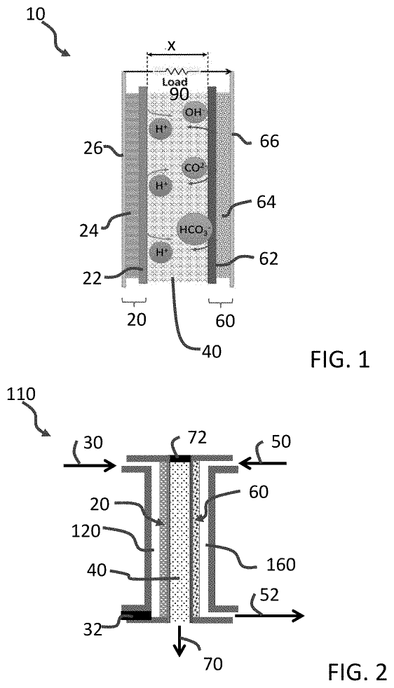

FIG. 1 is an illustration of a bipolar membrane cell 10 in a forward-bias configuration. FIG. 1 shows that a separation layer 40 is located in between an anode half-cell 20 and a cathode half-cell 60. The anode half-cell 20 can be an p-type proton conductive proton exchange membrane based anode half-cell membrane. The anode half-cell comprises a proton exchange membrane 22 and an anode 24. The proton exchange membrane 22 can be located in between the anode 24 and the separation layer 40. The anode 24 can be located on the proton exchange membrane 22 such that it is in direct physical contact with the proton exchange membrane 22 such that there are no intervening layers present. An anode side current collector 26 can be located on a surface of the anode 24 opposite of the proton exchange membrane 22. The anode side current collector 26 can be in direct physical contact with the anode 24 such that there are no intervening layers present.

The cathode half-cell 60 can be an n-type hydroxyl ion (OH⁻) conductive anion exchange membrane based cathode half-cell membrane. The cathode half-cell 60 comprises an anion exchange membrane 62 and a cathode 64. The anion exchange membrane 62 can be located in between the cathode 64 and the separation layer 40. The cathode 64 can be located on the anion exchange membrane 62 such that it is in direct physical contact with the anion exchange membrane 62 where there are no intervening layers present. A cathode side current collector 66 can be located on a surface of the cathode 64 opposite of the anion exchange membrane 62. The cathode side current collector 66 can be in direct physical contact with the cathode 64 such that there are no intervening layers present.

A hydrogen oxidation reaction occurs in the anode half-cell 20 where hydrogen is split into protons (H⁺) and electrons (e⁻) at the anode 24 according to the reaction (1).

H₂↔2H⁺+2e⁻ (1)

The electrons can be conducted through an external circuit 90 from the anode 24 to the cathode 64. The protons can be conducted through the proton exchange membrane 22 to the separation layer 40 due to the polarity of the voltage applied.

An oxygen reduction reaction occurs in the cathode half-cell 60. The oxygen reduction reaction uses electrons from the hydrogen oxidation reaction to react with oxygen and hydrogen at the cathode 64 to form hydroxyl ions (OH⁻) according to reaction (2).

O₂+4e⁻+2H₂O↔4OH⁻ (2)

Carbon dioxide present at the cathode 64 can react with water, the hydroxyl ions produced from reaction (2), or oxygen according to any of reactions (3)-(6).

CO₂+H₂O↔H₂CO₃ (3)

CO₂+OH⁻↔HCO₃⁻ (4)

CO₂+2OH⁻↔CO₃⁻+2H₂O (5)

CO₂+O₂+e⁻↔CO₃²⁻ (6)

The rate of capture of the carbon dioxide is generally dictated by reactions (4) and (5) that generally occur at faster rates than those of reactions (3) and (6). Water along with the hydroxyl ions formed from reaction (2), the carbonate ions (CO₃²⁻) formed from reaction (6), and the bicarbonate ions (HCO₃⁻) formed from reaction (4) can be conducted through the anion exchange membrane 62 to the separation layer 40.

The carbonate ions (CO₃²⁻) and the bicarbonate ions (HCO₃⁻) along with the hydroxyl ions (OH⁻) transported through the anion exchange membrane 62 can then react with the protons transported through the proton exchange membrane according to the acid-base reactions (7)-(9).

HCO₃⁻+H⁺↔H₂CO₃ (7)

CO₃²⁻+H⁺↔HCO₃⁻ (8)

OH⁻+H⁺↔H₂O (9)

Carbon dioxide can then be generated via reaction (3) using the carbonic acid (H₂CO₃) generated by reaction (7) or via reaction (4) using the bicarbonate ions (HCO₃⁻) transported through the anion exchange membrane 62 or generated by reaction (8). The carbon dioxide and water present in the separation layer 40 can then be removed from the separation layer 40.

When the two half-cell reactions of the system at the anode and cathode alone are considered, the overall redox potential of the cell)(E° can be 0.4 Volts (E_{reduction} of 0.4 minus E_{oxidation} of 0 Volts). Though it is less than the standard theoretical redox potential of a hydrogen fuel cell system (E°=1.23V), the remaining potential difference can be maintained at the bipolar interface due to possibility of a depletion layer formation. However, there can be enthalpic heat-losses, for example, up to −57 kilojoules per mole (kJ/mole) associated with the acid-base (H⁺/OH⁻) neutralization reactions that contribute up to 25% of Gibb's free energy (ΔG=−237 kJ/mole) of a standard hydrogen fuel cell. Furthermore, the ohmic losses due to ionic/electronic resistance of carbon layer along with overpotentials associated with electrode reactions can also contribute efficiency losses of the fuel cell.

Alternatively, when oxygen evolution reaction (OER) as in the reaction 10 occurs at anode half-cell 20 for generating protons that are required to conduct via PEM, the bipolar membrane would operate as an oxygen concentrating electrolyzer with overall theoretical cell potential requirement of −0.83V. The overall bipolar membrane cell would act as a composite device that captures-separates both oxygen and CO₂ from the direct-air.

2H₂O↔O₂+4H⁺+4e⁻ (10)

FIG. 2 is an illustration of an apparatus comprising a planar bipolar membrane cell 110 having a planar configuration. As used herein, the term planar refers merely to the respective planes of the anode half-cell 20 and the cathode half-cell 60 are substantially parallel each other (for example, within 0° (parallel) to 5°, or 0 to 2° of each other). It is noted that the two half-cells are not limited to parallel relationship to each other and other configurations are readily envisioned. FIG. 2 shows that a hydrogen rich stream 30 can be in fluid communication with an anode side chamber 120 of the planar bipolar membrane cell 110. Although not illustrated, a water vapor stream can be added to the anode side chamber 120 of the planar bipolar membrane cell 110. The water vapor stream can be combined with hydrogen rich stream 30 prior to introduction to the planar bipolar membrane cell 110 or can be added separately to the anode side chamber 120 of the planar bipolar membrane cell 110. The anode side chamber 120 can be a closed chamber as indicated by closed end 32 with only the incoming hydrogen rich stream 30 and optional water vapor stream entering. Conversely, a hydrogen withdrawal stream can be in fluid communication with the anode side chamber 120 to withdraw a spent stream from the anode side chamber 120.

A carbon dioxide source stream 50 can be in fluid communication with a cathode side chamber 160 of the planar bipolar membrane cell 110. The carbon dioxide source stream 50 can comprise at least one of a direct air stream or a flue-gas stream. A water vapor stream can be added to the cathode side chamber 160 of the planar bipolar membrane cell 110. The water vapor stream can be combined with carbon dioxide source stream 50 prior to introduction to the planar bipolar membrane cell 110 or can be added separately to the cathode side chamber 160 of the planar bipolar membrane cell 110. A carbon dioxide depleted stream 52 can be in fluid communication with the cathode side chamber 160 such that the carbon dioxide depleted stream 52 can be withdrawn from the bipolar membrane cell 110.

A carbon dioxide product stream 70 can be in fluid communication with the separation layer 40 to withdraw the carbon dioxide product from the planar bipolar membrane cell 110. The separation layer 40 can be housed in a closed chamber as indicated by closed end 72 with only one carbon dioxide product stream 70 in fluid communication with the closed chamber. Conversely, two or more carbon dioxide product streams 70 can be in fluid communication with the separation layer 40 to withdraw the carbon dioxide product from the planar bipolar membrane cell 110. The carbon dioxide stream can be directed to a phase separator for further separation.

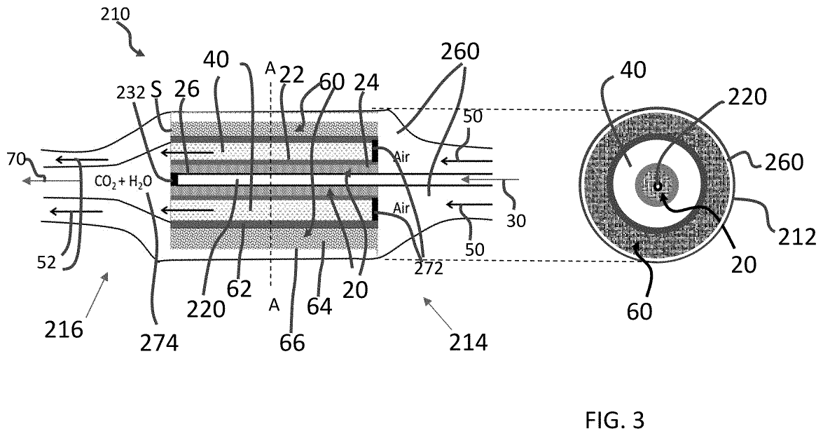

FIG. 3 is an illustration of bipolar membrane cell having a tubular configuration, tubular bipolar membrane cell 210, where the anode half-cell 20 and the cathode half-cell 60 form a concentric tube. In FIG. 3, the left-hand image is a cross-section along the length of the tube and the right-hand image is a cross-section along line A through a radial plane of the tube. FIG. 3 shows that a hydrogen rich stream 30 can be in fluid communication with an anode side chamber 220 of the tubular bipolar membrane cell 210. While it is illustrated that the hydrogen rich stream 30 enters from a proximal end 214 of the tube to elicit co-current flow of the hydrogen rich stream 30 and the carbon dioxide source stream 50, the hydrogen rich stream 30 could conversely enter from the distal end 216 of the tubular bipolar membrane cell 210 to elicit a counter-current flow with respect to the flow of the carbon dioxide source stream 50.

The anode side chamber 220 can form a center portion of the tubular bipolar membrane cell 210 with the anode half-cell 20 forming a tube around the center portion. The anode half-cell 20 can include the anode side current collector 26 on an inner surface of the anode half-cell 20 located on the proximal surface to the center portion, i.e., to the anode side chamber 220. The anode side current collector 26 can be porous. Although not illustrated, a water vapor stream can be added to the anode side chamber 220. The water vapor stream can be combined with hydrogen rich stream 30 prior to introduction to the tubular bipolar membrane cell 210 or can be added separately to the anode side chamber 220 of the tubular bipolar membrane cell 210. The anode side chamber 220 can be a closed chamber as indicated by closed chamber end 232 with only the incoming hydrogen rich stream 30 and optional water vapor stream entering. Conversely, a hydrogen withdrawal stream can be in fluid communication with the anode side chamber 220 to withdraw a spent stream from the anode side chamber 220, for example, through an opening at the chamber end 232. A phase-separator can be located at the outlet of the tubular bipolar membrane cell to separate the carbon dioxide from the water in carbon dioxide product stream 70.

A carbon dioxide source stream 50 can be in fluid communication with a cathode side chamber 260 of the tubular bipolar membrane cell 210 at a proximal end 214. While FIG. 3 illustrates that the cathode half cell 60 does not extend to the outer wall 212 of the tube, it is also envisioned that the cathode half cell 60 can extend to the outer wall 212, where the carbon dioxide depleted stream 52 can be collected from a surface S. A water vapor stream can be added to the cathode side chamber 260 of the tubular bipolar membrane cell 210. The water vapor stream can be combined with carbon dioxide source stream 50 prior to introduction to the tubular bipolar membrane cell 210 or can be added separately to the cathode side chamber 260 of the tubular bipolar membrane cell 210. A carbon dioxide depleted stream 52 can be in fluid communication with the cathode side chamber 260 such that the carbon dioxide depleted stream 52 can be withdrawn from the tubular bipolar membrane cell 210.

A carbon dioxide product stream 70 can be in fluid communication with the separation layer 40 to withdraw the carbon dioxide product from the tubular bipolar membrane cell 210. While it is illustrated that the carbon dioxide product stream 70 exits from a distal end 216 of the tube to elicit co-current flow of the carbon dioxide product stream 70 and the carbon dioxide source stream 50, the carbon dioxide product stream 70 could conversely or additionally be withdrawn from the distal end 214 of the tubular bipolar membrane cell 210 to elicit a counter-current flow or a bi-directional flow with respect to the flow of the carbon dioxide source stream 50.

The separation layer 40 can be housed in a closed chamber as indicated by closed product chamber end 272 with only one carbon dioxide product stream 70 in fluid communication with the closed chamber. Conversely, two or more carbon dioxide product streams 70 can be in fluid communication with the separation layer 40 to withdraw the carbon dioxide product from the tubular bipolar membrane cell 210.

It is noted that while FIG. 3 is illustrated as having the anode half-cell 20 as the inner most layer relative to the cathode half-cell 60 in the tubular bipolar membrane cell, their relative placement in the tube could be inverted such that the cathode half-cell 60 is internal to the anode half-cell 20. Likewise, multiple concentric layers of the anode half-cell 20 and the cathode half-cell 60 are possible.

The bipolar membrane cell can comprise flow field structures (not shown in the figures) that can be disposed on either side of the respective electrode structure(s). These structures can provide space for fluid flow in contact with the respective membrane electrode assembly (MEA).

The system can comprise a controller (not shown in the figures) in communication (e.g., via an electronic signal) with at least one of the respective half-cell layers, at least one of the streams, the power supply, or process control components such as pumps, mass-flow controller, heat exchangers, pressure control valves, or fluid control valves. In addition, an analyzer can be configured to quantify the concentration of the carbon dioxide in the carbon dioxide product stream 70. The controller can adjust one or more parameters during use to optimize the separation of the carbon dioxide.

The carbon dioxide source stream 50 can comprise air or an off-gas from an industrial process. The carbon dioxide source stream 50 can comprise up to 50 volume percent, or 0.001 to 30 volume percent of carbon dioxide based on the total volume of the stream on a dry basis (i.e., not including any water vapor that may be present). The carbon dioxide source stream 50 can comprise 10 to 15 volume percent of oxygen based on the total volume of the stream on a dry basis. The carbon dioxide source stream 50 can comprise non-reactive gases such as nitrogen, argon and helium in an amount of 10 to 70 volume percent of based on the total volume of the stream. The carbon dioxide source stream 50 can comprise air and the bipolar membrane cell can have a low-throughput, for example, having a low-current density of less than or equal to 50 milliampere per centimeter squared (mA/cm²). The carbon dioxide source stream 50 can comprise a flue gas and the bipolar membrane cell can have a high-throughput, for example, having a high-current density of greater than 50 mA/cm²).

The hydrogen rich stream 30 can comprise 90 to 100 volume percent, or 95 to 99 volume percent of hydrogen based on the total volume of the hydrogen rich stream 30 on a dry basis. The carbon dioxide product stream 70 can comprise 90 to 100 volume percent of carbon dioxide based on the total volume of the carbon dioxide product stream 70. The carbon dioxide product stream 70 can comprise 95 to 99 volume percent of water based on the total volume of the carbon dioxide product stream 70. The diffusion of the reactant gases from both the cathode and anode half-cell membranes can affect the overall aforementioned concentration range of CO₂ product stream 70. Alternatively, the CO₂ stream composition can change due to permeation if the bipolar device is operated at high-pressures, for example, in the range of 10 to 50 atmosphere.

The carbon dioxide stream 70 can be in fluid communication with a fuel cell for further upconverting to carbon-neutral hydrocarbons or fuels using a CO₂RENEW process. The carbon dioxide stream 70 can be in fluid communication with a direct-feed to CO₂ electrolyzer cell. The carbon dioxide stream 70 can be separated to form a carbon dioxide rich stream and a water stream, for example, using a phase-separator. The carbon dioxide stream 70 can be compressed to high-pressure gas or condensed into liquid. The carbon dioxide stream 70 can be directed to a storage container.

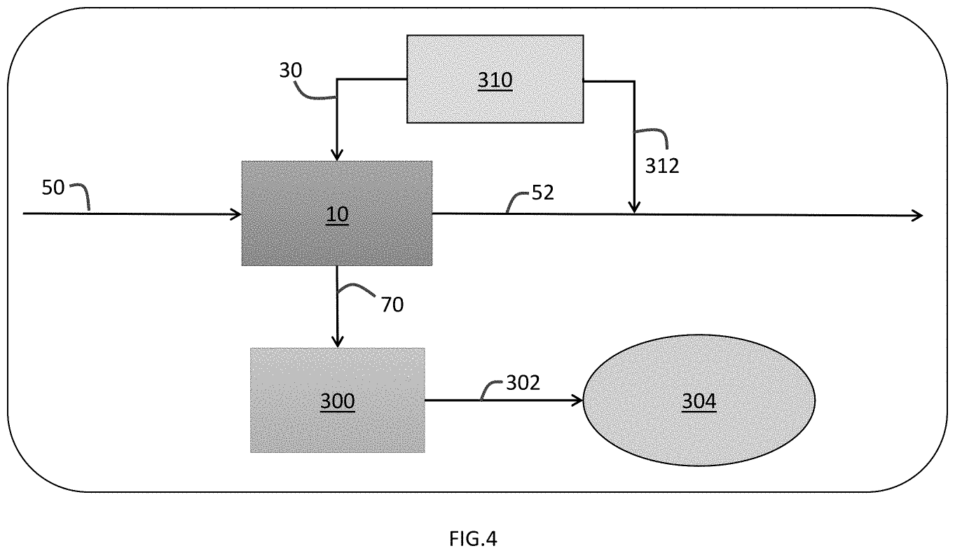

FIG. 4 is an illustration of overall supporting system (Balance of plant—BOP) comprising the bipolar membrane cell 10 in fluid communication with a CO₂RENEW process 300. In this aspect, the carbon dioxide stream 70 can be in fluid communication with a PEM-based CO₂-electrolyzer cathode for further upconverting to for carbon-neutral hydrocarbon stream 302 using a CO₂RENEW process as is commercially available from Skyre, Inc. Carbon-neutral hydrocarbon stream 302 can optionally be stored in storage tank 304. Water electrolyzer 310 can electrolyze water into hydrogen to form hydrogen rich stream 30 and oxygen to form oxygen stream 312. Hydrogen rich stream 30 can be in fluid communication with the bipolar membrane cell 10 at the anode. Carbon dioxide source stream 50 can be in fluid communication with the bipolar membrane cell 10. The carbon dioxide depleted stream 52 can be combined with oxygen stream 312.

A method of purifying a carbon dioxide stream can comprise directing the carbon dioxide source stream 50 comprising carbon dioxide to a cathode side chamber 160,260 comprising a cathode half-cell 60. The cathode half-cell 60 can comprise the anion exchange membrane 62 and the cathode 64, where the cathode 64 is located on a side of the anion exchange membrane 62 proximal to the cathode side chamber 160,260. The carbon dioxide depleted stream 52 can be withdrawn from the cathode side chamber 160,260. The carbon dioxide can be reacted with water at the cathode 64 to form carbonate ions and bicarbonate ions. The carbonate ions and the bicarbonate ions can be directed through the anion exchange membrane 62 to the separation layer 40. The hydrogen rich stream 30 comprising hydrogen can be directed to the anode side chamber 120, 220. The anode side chamber 120, 220 can comprise the proton exchange membrane 22 and the anode side current collector 26. The anode side current collector 26 can be located on a side of the proton exchange membrane 22 proximal to the anode side chamber 120, 220.

The hydrogen can be reacted at the anode 24 to form protons and electrons and the protons can be directed through the proton exchange membrane 22 to the separation layer 40. The protons, the carbonate ions, and the bicarbonate ions can be reacted in the separation layer 40 to form carbon dioxide and water. The carbon dioxide product stream 70 comprising the carbon dioxide and the water can be withdrawn from the separation layer 40.

At least a portion of the carbon dioxide product stream 70 can be directed to at least one of a separation unit, a storage unit, a further electrochemical cell.

The separation layer 40 can comprise a porous carbon. The porous carbon can comprise at least one of graphene (for example, a doped graphene or a functionalized graphene), graphene oxide (for example, a reduced graphene oxide), graphene fluoride, graphite, expanded graphite (for example, with an inter-graphene spacing greater than or equal to 0.4 nanometers), activated carbon, carbon black, carbon nanotubes, carbon fibers, graphite fibers, carbonized polymer fibers, or chemically treated coke.

The porous carbon can include at least one of a microporosity having pore diameters of less than 2 nanometer or a mesoporosity having pore diameters of 2 to 50 nanometers. A ratio of the microporosity to the mesoporosity can be 20:80 to 50:50 volume percent. The porous carbon can have a total pore volume of 0.0001 to 0.1 centimeters cubed per gram. The porous carbon can have a BET surface area of 2 to 500 meters squared per gram (m²/g), or 100 to 2,000 m²/g, or 500 to 1,000 m²/g. The specific surface area (SSA) and pore-volume of the carbon could be measured using via a single-point or a multi-point Nitrogen-physisorption techniques. The SSA could be derived based on the Nitrogen physiosorbed at a single-point partial pressure of 0.3 (approximate BET monolayer coverage) whereas the pore-volume could be estimated based on the volume of liquid nitrogen condensed at a Nitrogen partial-pressure of >0.99 to 1. The porous carbon can have an electrical conductivity of greater than or equal to 10⁻² Siemens per centimeter (S/cm). The electrical conductivity of the carbon material can be measure using a four-probe measurement after sandwiching between two thin copper layers.

A thickness of the separation layer 40, x, should be thin enough to have a minimum ohmic loss. For example, the thickness, x, can be 0.25 micrometer to 5 millimeters, or 1 micrometer to 1 millimeter.

The porous carbon layer can have a mixed ionic conductivity of both acidic-cations (H⁺) and alkaline-anions (OH⁻/CO₃²⁻/HCO₃⁻). For example, the porous carbon layer can comprise a charged coating layer. The charged coating layer can be a solid electrolyte layer. The charged coating layer can be formed by mixing at least one of a proton conducting ionomer or an alkaline ion conducting ionomer and coating the mixture on the porous carbon. The coating mixture can comprise 5 to 10 weight percent of the proton conducting ionomer or 1 to 20 weight percent of the alkaline ion conducting ionomer both based on the total weight of the coating mixture.

The separation layer can comprise the porous carbon and a fluoropolymer (for example, polytetrafluoroethylene (PTFE) or polyvinylidene fluoride (PVDF)). The fluoropolymer can increase the hydrophobicity of the separation layer. The fluoropolymer can be negatively charged, for example, a sulfonated tetrafluoroethylene. The separation layer can be formed by mixing carbon with the fluoropolymer and heating at a temperature of 200 to 600° C., or 300 to 350° C. in an inert atmosphere.

The electrodes (anode 24 and/or cathode 64) can be in direct physical contact with their respective exchange membrane 50 and can cover 90 to 100% of the respective surface areas of the exchange membrane 22 and 62, respectively. Each electrode independently comprises a catalyst layer. The catalyst layer of the anode 24 can be capable of dissociating hydrogen into protons and electrons. The catalyst layer of the cathode 64 can be capable of catalyzing the oxygen reduction reactions thereby generating hydroxyl ions followed by conversion of bicarbonate ions, and bicarbonate ions when reacted with CO₂ present in the reactant feed at the cathode. The catalyst layer of the cathode can comprise at least one of platinum, palladium, rhodium, carbon, gold, tantalum, tungsten, ruthenium, iridium, osmium, nickel, manganese, iron, cobalt, tungsten, or silver. The catalyst layer of the anode 24 can comprise platinum or a composite or an alloy formed with platinum-group-metals. The catalyst layer of the cathode 64 can comprise at least one of aluminum, nickel, or platinum. The catalyst layer of the cathode 64 can comprise a non-platinum group metal (for example, a transition metal based MNₓ-based catalyst). The catalyst layer of the cathode 64 can comprise at least one of rhodium, carbon, gold, tantalum, tungsten, ruthenium, iridium, osmium, or silver. The respective catalysts can each independently comprise a bound catalyst. The binder can comprise at least one of a fluoropolymer or a particulate carbon. The respective catalysts and optional binder can be deposited directly onto the surfaces of the proton exchange membrane. The respective catalysts can each independently be disposed on a gas diffusion layer such that it is located throughout the gas diffusion layer or on a surface of the gas diffusion layer that is in contact with the proton exchange membrane. The gas diffusion layer can be porous. The gas diffusion layer can be a mesh. The gas diffusion layer can comprise a graphitic material. The gas diffusion layer can comprise a plurality of fibers such as carbon fibers. The gas diffusion layer can be electrically conductive.

The catalyst loading at the cathode 64 can be minimized, for example, comprising less than or equal to 1 milligram per centimeter squared (mg/cm²). Including a reduced amount of catalyst at the cathode 64 can help to limit the excess hydroxyl ion (OH⁻) generation, which could directly conduct through the anion exchange membrane 62 and promote the water production upon combining with H⁺ in order to avoid a major side-reaction. The effective surface area of the cathode 64 can be 200 to 1,000 meters squared per gram (m²/g) to increase the CO₂ gas interaction with the catalyst and therefore to improve the overall CO₂ capture efficiency.

The proton exchange membrane can comprise an ionomer-type polyelectrolyte comprising an amount of ionic groups on a hydrophobic backbone or on pendent groups off of the hydrophobic backbone such as a hydrocarbon- and fluorocarbon-type resin. The hydrocarbon-type ion-exchange resin can comprise at least one of a phenolic resin or a polystyrene. The hydrocarbon-type ion-exchange resin can be sulfonated, for example, a sulfonated poly(xylylene oxide). The hydrocarbon-type ion-exchange resin can comprise a proton conducting molecule, for example, at least one of a fullerene molecule, a carbon fiber, or a carbon nanotube. The proton conducting molecules can comprise proton dissociation groups, for example, at least one of —OSO₃H, —OPO(OH)₂, —COOH, —SO₃H, —C₆H₄, —SO₃H, or —OH. The proton conducting molecules alone can form the proton exchange membrane or can be present as a mixture with a binder polymer such as at least one of a fluoropolymer (for example, polyfluoroethylene or poly(vinylidene fluoride)) or poly(vinyl alcohol). As oxygen is not present in a significant amount in the proton exchange membrane, the concern for oxidation is low, and the proton exchange membrane can comprise a hydrocarbon-type ion-exchange resin.

The fluorocarbon-type ion-exchange resin can include a hydrate of at least one of tetrafluoroethylene-perfluorosulfonyl ethoxyvinyl ether or tetrafluoroethylene-hydroxylated (perfluoro vinyl ether) copolymer. The fluorocarbon-type ion-exchange resin can have at least one of a sulfonic, a carboxylic, or a phosphoric acid functionality. The fluorocarbon-type ion-exchange resin can be a sulfonated fluoropolymer (such as a lithium salt of perfluoroethylene sulfonic acid). An example of fluorocarbon-type ion-exchange resin is NAFION that is commercially available from DuPont. The proton exchange membrane itself can act as a barrier—allowing the transport of protons across is thickness from the anode 24 (feed side) to the separation layer 40 (discharge side)—rejecting other constituents present in the hydrogen rich stream. The proton exchange membrane is generally only conductive to protons when it is hydrated. The maximum electrical performance of the electrochemical device can be achieved when the membrane is fully in the acid form; i.e. the sulfonic acid groups in the proton exchange membrane are fully protonated as the hydrogen ion is capable of coordinating significant water around the sulfonic acid groups.

The proton exchange membrane 22 can have a membrane thickness of 25 to 550 micrometers, or 75 to 550 micrometers, or 100 to 300 micrometers.

The anion exchange membrane 62 can be selectively permeable to carbonate anions. The anion exchange membrane 62 can be formed from any material that will permit carbonate anions to diffuse through. For example, the anion exchange membrane 62 can comprise at least one of a polyolefin, tetrafluoroethylene (TFE), fluorinated ethylenepropylene/TFE (FEP/TFE), polystyrene divinylbenzene (PS-DVB) on nylon, PS-DVB on polytetrafluoroethylene (PTFE), or PS-DVB on polyvinyl chloride. Suitable membranes are available from available from Versogen, particularly their Piperlon and Orion's AMX-membranes; Ionics Incorporated (Watertown, Mass.), particularly their AR-204 and AR-708 membranes; Pall RAI, Inc. (Hauppauge, N.Y.), particularly their R1030 and R4030 membranes; Tokuyama Soda (Tokyo, Japan), particularly their AMH membrane; Asahi Glass America, Inc. (New York, N.Y.), particularly their AAV and AMP membranes; and Tosoh Corporation (Tokyo, Japan), particularly their Tosflex membrane.

The anion exchange membrane 62 can have a membrane thickness of 25 to 550 micrometers or 75 to 550 micrometers.

Set forth below are non-limiting aspects of the present disclosure. The aspects can be combined with one or more of the listed aspects.

Aspect 1: A bipolar membrane cell comprising: a separation layer located in between an anode half-cell and a cathode half-cell; wherein the anode half-cell comprises a proton exchange membrane and an anode; where the proton exchange membrane is located in between the anode and the separation layer; wherein the cathode half-cell comprises an anion exchange membrane and a cathode; wherein the anion exchange membrane is located in between the cathode and the separation layer; and an external circuit connecting the anode and the cathode.

Aspect 2: The cathode half-cell can further comprise a cathode side chamber and a carbon dioxide source stream in fluid communication with the cathode side chamber for delivering carbon dioxide to the cathode side chamber.

Aspect 3: The cathode half-cell can further comprise a cathode side chamber and a carbon dioxide depleted stream in fluid communication with the cathode side chamber for withdrawing the carbon dioxide depleted stream from the cathode side chamber.

Aspect 4: The anode half-cell can further comprise an anode side chamber and a hydrogen rich stream in fluid communication with the anode side chamber for delivering the hydrogen rich stream from the anode side chamber.

Aspect 5: The separation layer, the anode half-cell, and the cathode half-cell can have a planar configuration relative to each other.

Aspect 6: The anode half-cell and the cathode half-cell can be concentrically located to form a tubular bipolar membrane cell; and the separation layer can be concentrically located in between the anode half-cell and the cathode half-cell. The anode half-cell can be located in a tube formed by the cathode half-cell. The cathode half-cell can be located in a tube formed by the anode half-cell. Both the hydrogen rich stream and the carbon dioxide source stream can be in fluid communication with a proximal end of the tubular bipolar membrane cell and the carbon dioxide product stream can be in fluid communication with a distal end of the tubular bipolar membrane cell. Both the carbon dioxide product stream and the carbon dioxide source stream can be in fluid communication with a proximal end of the tubular bipolar membrane cell and the hydrogen rich stream and can be in fluid communication with a distal end of the tubular bipolar membrane cell.

Aspect 7: The anode can comprise platinum and the cathode can comprise at least one of a non-platinum group metal.

Aspect 8: At least one of the separation layer can comprise a porous carbon. The porous carbon can have a microporosity having pore diameters of less than 2 nanometer. The porous carbon can have a mesoporosity having pore diameters of 2 to 50 nanometers. A total pore volume of the porous carbon can be 0.0001 to 0.1 centimeters cubed per gram. A BET surface area of the porous carbon can be 2 to 500 m²/g, or 100 to 2,000 m²/g, or 500 to 1,000 m²/g. An electrical conductivity of the porous carbone can be greater than or equal to 10⁻² S/cm.

Aspect 9: The separation layer can have a thickness of 0.25 micrometer to 5 millimeters, or 1 micrometer to 1 millimeter.

Aspect 10: The bipolar membrane cell can further comprise a hydrogen withdrawal stream in fluid communication with the anode side chamber.

Aspect 11: A method of purifying a carbon dioxide stream; can comprise directing the carbon dioxide source stream comprising carbon dioxide to a cathode side chamber comprising a cathode half-cell that comprises an anion exchange membrane and a cathode; where the cathode is located on a side of the anion exchange membrane proximal to the cathode side chamber; and withdrawing a carbon dioxide depleted stream from the cathode side chamber; reacting the carbon dioxide with water at the cathode to form carbonate ions and bicarbonate ions and directing the carbonate ions and the bicarbonate ions through the anion exchange membrane to a separation layer; directing a hydrogen rich stream comprising hydrogen to an anode side chamber comprising an anode half-cell comprising a proton exchange membrane and an anode; where the anode is located on a side of the proton exchange membrane proximal to the anode side chamber; reacting the hydrogen at the anode to form protons and electrons and directing the protons through the proton exchange membrane to the separation layer; reacting the protons, the carbonate ions, and the bicarbonate ions in the separation layer to form carbon dioxide and water; and withdrawing a carbon dioxide product stream from the separation layer comprising the carbon dioxide and the water.

Aspect 12: The method can further comprise directing at least a portion of the carbon dioxide product stream to at least one of a separation unit, a storage unit, or to a direct-feed to CO₂ electrolyzer cell.

Aspect 13: The carbon dioxide source stream can comprise at least one of air or an off-gas from an industrial process.

Aspect 14: The carbon dioxide source stream can comprise up to 50 volume percent of carbon dioxide based on the total volume of the stream on a dry basis.

Aspect 15: The hydrogen rich stream can comprise 90 to 100 volume percent, or 95 to 99 volume percent of hydrogen based on the total volume of the hydrogen rich stream 30 on a dry basis.

Aspect 16: The carbon dioxide product stream can comprise 90 to 100 volume percent of carbon dioxide based on the total volume of the carbon dioxide product stream.

Aspect 17: The carbon dioxide product stream can be directed to at least one of a separation unit, a storage unit, or a CO₂ electrolyzer.

An apparatus can comprise the bipolar membrane cell; an optional water electrolyzer in fluid communication with an inlet of the bipolar membrane cell via a hydrogen rich stream; and an optional CO₂ electrolyzer in fluid communication with an outlet of the bipolar membrane cell via carbon dioxide stream 70.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

As used herein, “a,” “an,” “the,” and “at least one” do not denote a limitation of quantity, and are intended to cover both the singular and plural, unless the context clearly indicates otherwise. For example, “an element” has the same meaning as “at least one element,” unless the context clearly indicates otherwise. The term “combination” is inclusive of blends, mixtures, alloys, reaction products, and the like. Also, “at least one of” means that the list is inclusive of each element individually, as well as combinations of two or more elements of the list, and combinations of at least one element of the list with like elements not named.

The term “or” means “and/or” unless clearly indicated otherwise by context. Reference throughout the specification to “an aspect”, “another aspect”, “some aspects”, and so forth, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 vol %, or 5 to 20 vol %” is inclusive of the endpoints and all intermediate values of the ranges of “5 to 25 vol %,” such as 10 to 23 vol %, etc.)

Unless defined otherwise, technical and scientific terms used herein have the same meaning as is commonly understood by one of skill in the art to which this disclosure belongs.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A bipolar membrane cell comprising:
a separation layer located in between an anode half-cell and a cathode half-cell;
wherein the anode half-cell comprises a proton exchange membrane and an anode; where the proton exchange membrane is located in between the anode and the separation layer;
wherein the cathode half-cell comprises an anion exchange membrane and a cathode; wherein the anion exchange membrane is located in between the cathode and the separation layer; and
an external circuit connecting the anode and the cathode.

2. The bipolar membrane cell of claim 1, wherein the cathode half-cell further comprises a cathode side chamber and a carbon dioxide source stream in fluid communication with the cathode side chamber for delivering carbon dioxide to the cathode side chamber.

3. The bipolar membrane cell of claim 2, wherein the cathode half-cell further comprises a cathode side chamber and a carbon dioxide depleted stream in fluid communication with the cathode side chamber for withdrawing the carbon dioxide depleted stream from the cathode side chamber.

4. The bipolar membrane cell of claim 3, wherein the anode half-cell further comprises an anode side chamber and a hydrogen rich stream in fluid communication with the anode side chamber for delivering the hydrogen rich stream from the anode side chamber.

5. The bipolar membrane cell of claim 4, wherein the separation layer, the anode half-cell, and the cathode half-cell have a planar configuration relative to each other.

6. The bipolar membrane cell of claim 5, wherein the anode half-cell and the cathode half-cell are concentrically located to form a tubular bipolar membrane cell; and wherein the separation layer is concentrically located in between the anode half-cell and the cathode half-cell.

7. The bipolar membrane cell of claim 6, wherein the anode half-cell is located in a tube formed by the cathode half-cell; or wherein the cathode half-cell is located in a tube formed by the anode half-cell.

8. The bipolar membrane cell of claim 7, wherein the both the hydrogen rich stream and the carbon dioxide source stream are in fluid communication with a proximal end of the tubular bipolar membrane cell and wherein the carbon dioxide product stream is in fluid communication with a distal end of the tubular bipolar membrane cell.

9. The bipolar membrane cell of claim 7, wherein the both the carbon dioxide product stream and the carbon dioxide source stream are in fluid communication with a proximal end of the tubular bipolar membrane cell and wherein the hydrogen rich stream and is in fluid communication with a distal end of the tubular bipolar membrane cell.

10. The bipolar membrane cell of claim 1, wherein the anode comprises platinum and the cathode comprises at least one of a non-platinum group metal.

11. The bipolar membrane cell of claim 1, wherein at least one of the separation layer comprises a porous carbon or wherein the separation layer has a thickness of 0.25 micrometer to 5 millimeters, or 1 micrometer to 1 millimeter.

12. The bipolar membrane cell of claim 11, wherein the separation layer comprises the porous carbon and wherein the porous carbon has at least one of a microporosity having pore diameters of less than 2 nanometer, a mesoporosity having pore diameters of 2 to 50 nanometers, a total pore volume of 0.0001 to 0.1 centimeters cubed per gram, a BET surface area of 2 to 500 m²/g, or 100 to 2,000 m²/g, or 500 to 1,000 m²/g, or an electrical conductivity of greater than or equal to 10⁻² S/cm.

13. The bipolar membrane cell of claim 1, further comprising a hydrogen withdrawal stream in fluid communication with the anode side chamber.

14. An apparatus comprising:
the bipolar membrane cell of claim 1;
a water electrolyzer in fluid communication with an inlet of the bipolar membrane cell via the hydrogen rich stream; and
a CO₂ electrolyzer in fluid communication with an outlet of the bipolar membrane cell via the carbon dioxide stream.

15. A method of purifying a carbon dioxide stream; comprising
directing the carbon dioxide source stream comprising carbon dioxide to a cathode side chamber comprising a cathode half-cell that comprises an anion exchange membrane and a cathode; where the cathode is located on a side of the anion exchange membrane proximal to the cathode side chamber; and withdrawing a carbon dioxide depleted stream from the cathode side chamber;
reacting the carbon dioxide with water at the cathode to form carbonate ions and bicarbonate ions and directing the carbonate ions and the bicarbonate ions through the anion exchange membrane to a separation layer;
directing a hydrogen rich stream comprising hydrogen to an anode side chamber comprising an anode half-cell comprising a proton exchange membrane and an anode; where the anode is located on a side of the proton exchange membrane proximal to the anode side chamber;
reacting the hydrogen at the anode to form protons and electrons and directing the protons through the proton exchange membrane to the separation layer;
reacting the protons, the carbonate ions, and the bicarbonate ions in the separation layer to form carbon dioxide and water; and
withdrawing a carbon dioxide product stream from the separation layer comprising the carbon dioxide and the water.

16. The method of claim 15, further comprising directing at least a portion of the carbon dioxide product stream to at least one of a separation unit, a storage unit, a further direct-feed to CO2 electrolyzer cell.

17. The method of claim 16, wherein the carbon dioxide source stream comprises at least one of air or an off-gas from an industrial process.

18. The method of claim 17, wherein the carbon dioxide source stream comprises up to 50 volume percent of carbon dioxide based on the total volume of the stream on a dry basis.

19. The method of claim 18, wherein the hydrogen rich stream comprise 90 to 100 volume percent, or 95 to 99 volume percent of hydrogen based on the total volume of the hydrogen rich stream 30 on a dry basis.

20. The method of claim 19, wherein the carbon dioxide product stream comprises 90 to 100 volume percent of carbon dioxide based on the total volume of the carbon dioxide product stream.
